(19) United States
(12) Patent Application Publication
(10) Pub. No.: US 2009/0173906 A1
(43) Pub. Date: Jul. 9, 2009

(54) Ethylene Vinyl Acetate Based Polymer Foams with Low Density, Injection Preparation Method Thereof and a Material for Medical and Health-Care use

(75) Inventors: Young Kum Park, Seoul (KR); Ho Min Bae, Busan (KR); Dong Ho Park, Gyeongsangnam-do (KR); Ju-Yeon Lee, Busan (KR); Jung Ho Song, Busan (KR)

Correspondence Address: Ronald R. Santucci;Frommer Lawrence & Haug, 745 Fifth Avenue, New York, NY, 10151, US

(73) Assignee: COMTECH CHEMICAL CO., LTD., Gyeongsangnam-do (KR)

(21) Appl. No.: 11/597,727

(22) PCT Filed: Oct. 20, 2006
(86) PCT No.: PCT/KR2006/004291

§ 371 Date: Nov. 27, 2006

(30) Foreign Application Priority Data
Oct. 21, 2005 (KR) 10-2005-0099692

(51) Int. Cl. C08L 31/04; H01F 1/00; B29C 65/00

(52) U.S. Cl. 252/62.54; 521/134; 264/41

(57) ABSTRACT

The present invention relates to ethylene vinyl acetate based polymer foams with low density and superior injection molding characteristics, a preparation method thereof and a material for medical and health-care use using the same, more particularly to ethylene vinyl acetate based polymer foams with low density prepared by blending, masticating, pelletizing and foaming a matrix resin comprising ethylene vinyl acetate (EVA) resin and ethylene methyl acrylate (EMA) resin under specific condition, which has low density and superior injection molding characteristics and improved biocompatibility to human body, making them a useful environment-friendly material and particularly applicable to medical or health-care use, a preparation method thereof and a material for medical and health-care use using the same.

### TECHNICAL FIELD

The present invention relates to ethylene vinyl acetate based polymer foams with low density and superior injection molding characteristics, a preparation method thereof and a material for medical and health-care use using the same, more particularly to ethylene vinyl acetate based polymer foams with low density prepared by blending, masticating, pelletizing and foaming a matrix resin comprising ethylene vinyl acetate (EVA) resin and ethylene methyl acrylate (EMA) resin under specific conditions, which has low density and superior injection molding characteristics, improved biocompatibility to human body, making them a useful environment-friendly material, in particular applicable to a medical or health-care use, a preparation method thereof and a material for medical and health-care use using the same.

### BACKGROUND ART

The specialty foam market has been continuously expanding along with the economical growth and the increase in demand on high functional materials in the fields of electricity/electronics, state-of-the-art industries and medicine. Especially, the demand on foams for medical and health-care use is expected to grow more rapidly with the recent spread of the so-called ‘well-being culture’.

Until now, most of the materials used in Korean-made medical and health-care products are polyurethane or polyethylene based polymer foams.

However, the polyurethane or polyethylene based polymer foams are disadvantageous in that the surface touch is not smooth and there occur hydrolysis and discoloration as time goes by.

In contrast, low density EVA foams have superior stability against hydrolysis and discoloration and are considered as environment-friendly materials because they do not produce toxic gases or byproducts when incinerated. However, they have very poor injection molding characteristics regarding the manufacturing process.

With the rapid market growth accompanied by the new concept of well-being culture, there is a need for the development of advanced materials with improved softness, lightweightness, biocompatibility to human body, environmental friendliness, etc., as compared with the existing materials that can be used for medical foams.

### DISCLOSURE OF THE INVENTION

The inventors of the present invention have made efforts to solve the aforementioned problems of the polyurethane or polyethylene polymer foams. As a result, they have discovered that it is possible to perform an injection molding when a matrix resin comprising ethylene vinyl acetate (EVA) resin and ethylene methyl acrylate (EMA) resin with a specific ratio is blended, masticated, palletized and foamed under specific conditions.

In addition, they have discovered that the ethylene vinyl acetate foams of the present invention have small specific gravity and low density.

Accordingly, an object of the present invention is to provide ethylene vinyl acetate foams with low density having improved smoothness, light and soft touch, and particularly, improved injection molding characteristics suitable for use in medical and health-care products and a preparation method thereof.

The present invention relates to injection-molded ethylene vinyl acetate based polymer foams comprising a mixture matrix resin of 50-90 parts by weight of ethylene vinyl acetate (EVA) resin and 10-50 parts by weight of ethylene methyl acrylate (EMA) resin and having a hardness of 15-18 and a specific gravity of 0.16-0.18.

The present invention also relates to a preparation method of injection-molded ethylene vinyl acetate based polymer foams comprising the steps of blending a matrix resin comprising 50-90 parts by weight of ethylene vinyl acetate (EVA) resin and 10-50 parts by weight of ethylene methyl acrylate (EMA) resin in the temperature range of 80-120° C.; and masticating, pelletizing and foaming the resultant blend.

The present invention further relates to medical and health-care products in which the injection-molded ethylene vinyl acetate based polymer foams with low density are used.

Hereunder is given a detailed description of the present invention.

The present invention relates to ethylene vinyl acetate based polymer foams with low density prepared by blending, masticating, pelletizing and foaming a matrix resin comprising ethylene vinyl acetate (EVA) resin and ethylene methyl acrylate (EMA) resin under specific conditions, which has low density, superior injection molding characteristics and improved biocompatibility to human body, making them a useful environment-friendly material and particularly applicable to medical or health-care use, a preparation method thereof and a material for medical and health-care use using the same.

Hereunder is given a detailed description of each component of the ethylene vinyl acetate based polymer foams of the present invention.

First, the ethylene vinyl acetate based polymer foams of the present invention is prepared from a mixture matrix resin comprising ethylene vinyl acetate (EVA) resin and ethylene methyl acrylate (EMA) resin.

The EVA resin is known environment-friendly, unharmful to human body and highly biocompatible to human body, thus being an excellent candidate material for medical or health-care use. However, due to its poor hardness, injection molding is much restricted and thus the resultant foams have high shrinkage. By blending the EVA resin with EMA resin, which has superior flow characteristics, formability and shrinkage resistance, the present inventors have solved the aforesaid problem and obtained low density foams having superior injection molding characteristics.

The low density EVA based foams of the present invention comprises a matrix resin comprising 50-90 parts by weight of EVA resin and 50-10 parts by weight of EMA resin. If the content of the EVA resin is below 50 parts by weight or if the content of the EMA resin exceeds 50 parts by weight, the resultant foams become too hard to be used for health-care or medical products. In contrast, if the content of the EVA resin exceeds 90 parts by weight or if the content of the EMA resin is below 10 parts by weight, the resultant foams have an extreme shrinkage, thereby leading to significant change in the shape of the injection-molded product. Therefore, the control of the contents of the EVA resin and the EMA resin comprising the matrix resin is very important.

In addition to the matrix resin, the low density EVA based foams of the present invention comprise various additives including a processing aid, a foaming aid, a flow enhancer, a lubricant, a crosslinking agent and a foaming agent. That is, the low density EVA based foams of the present invention comprise, per 100 parts by weight of the matrix resin mixture comprising the ethylene vinyl acetate (EVA) resin and the ethylene methyl acrylate (EMA) resin, 1-3 parts by weight of a processing aid, 0.5-2 parts by weight of a foaming aid, 1-2 parts by weight of a flow enhancer, 4-20 parts by weight of a lubricant, 0.6-1.1 parts by weight of a crosslinking agent and 3-4 parts by weight of a foaming agent. The low density EVA based foams of the present invention have a relatively low hardness of 15-18, a specific gravity of 0.16-0.18 and superior injection molding characteristics.

The processing aid improves processing characteristics and dispersibility during the manufacture of the foams and can be selected by those skilled in the art from the processing aids commonly utilized in the related field. Specific but non-restrictive examples of the processing aid include stearic acid (St/A), commercially available TR-141 (MS SEK, mainly stearamide), etc. The processing aid is comprised in the amount of 1-3 parts by weight. If its content is below 1 part by weight, the processing becomes difficult because the processing aid adheres to the roll mill. In contrast, if the content exceeds 3 parts by weight, the expansion ratio increases significantly.

The foaming aid can ensure a uniform heat transfer and stabilize the rate of crosslinking. The foaming aid can be selected by those skilled in the art from the foaming aids commonly utilized in the related field. Specific but non-restrictive examples of the foaming aid include those mainly composed of zinc oxide (ZnO)—ZnO No. 2 and ZnO No. 1 commercially available from Gilcheon; C-30 commercially available from PCC (Taiwan). The foaming aid is comprised in the amount of 0.5-2 parts by weight. If the content is below 0.5 part by weight, foaming is not smoothly proceeded and it also requires much time for foaming. In contrast, if it exceeds 2 parts by weight, the foaming aid may become chemically reactive with other additives, thereby leading to discoloration and worsening of the foaming conditions.

The flow enhancer prevents initial coloration and assists injection. The flow enhancer can be selected by those skilled in the art from the flow enhancers commonly utilized in the related field. Specific, but non-restrictive examples of the flow enhancer include those comprising zinc stearate (Zn/St), etc., as an effective ingredient. Examples of commercially available products are PE-WAX (BASF), etc. The flow enhancer is comprised in the amount of 1-2 parts by weight. If the content is less than 1 part by weight, the time required to feed raw materials into the injection molding machine and the injection time increase. In contrast, if it exceeds 2 parts by weight, thermal stability becomes worsened.

A preferred lubricant is the one that can reduce hardness but hardly affects the crosslinking and foaming reactions. Specifically, a variety of process oils, for example, W-oil available from Sechang Petrochemical and P-90 and W-1000 available from Michang Petroleum, may be used. The lubricant is comprised in the amount of 4-20 parts by weight. If its content is below 4 parts by weight, wanted physical properties cannot be attained because of insufficient hardness. In contrast, if it exceeds 20 parts by weight, unwanted injection molding occurs because of improper crosslinking and foaming.

For the crosslinking agent, one that does not give off a pungent odor in the final injection-molded foams can be used. Specifically, those comprising dicumyl peroxide (DCP), t-butylperoxyisopropylbenzene (BIPB), etc. as effective ingredient may be used. The crosslinking agent is comprised in the amount of 0.6-1.1 parts by weight. If the content is below 0.6 part by weight, crosslinking time increases and shaping becomes difficult during the injection. In contrast, if it exceeds 1.1 parts by weight, the product tends to be torn or foamed earlier because of increased crosslinkage.

For the foaming agent, one that is non-toxic and self-extinguishing, has superior foaming properties at elevated temperature and gives off a lot of gas during foaming may be used. Specifically, those comprising azodicarbonamide, etc., as an effective ingredient may be used. Such commercially available foaming agents as DX-74H (Dongjin), AD/E (Kumyang Chemical), Cellcom F (Kumyang Chemical), AC 3000 (Kumyang Chemical), etc., may be used. The foaming agent is comprised in the amount of 3-4 parts by weight. If the content is below 3 parts by weight, the resulting hardness becomes unfavorable because of reduced expansion ratio. In contrast, if it exceeds 4 parts by weight, it becomes difficult to obtain the product because of the increased expansion ratio.

In addition to the components described above, additives commonly used to process foams may be added, as required. Specifically, a pigment, a filler, n antioxidant, an age resistor, etc., may be used. Use of these additives may be determined by those skilled in the art unless it negatively affects the physical properties of the EVA based foams of the present invention.

Further, in order to improve antibacterial effect, flavor, etc., the low density EVA based foams of the present invention may comprise at least one selected from silver nanoparticles, green tea extract, wormwood extract, pine needle extract, powdered magnetic material, etc. The silver nanoparticles, green tea extract, wormwood extract, pine needle extract, powdered magnetic material, etc., may improve the antibacterial effect, the flavor, etc., of the foams.

Preferably, the silver nanoparticles have a diameter of 20-200 nm, more preferably 60-180 nm, and may be silver nanopowder, silver nanocolloidal particles, etc. The silver nanoparticles are used in 0.1-1.0 part by weight, preferably in 0.2-0.3 part by weight, per 100 parts by weight of the matrix resin mixture. If the content of the silver nanoparticles is below 0.1 part by weight, sufficient antibacterial effect cannot be attained. In contrast, if it exceeds 1.0 part by weight, the product may be discolored.

The green tea extract may be used to improve flavor, particularly to offer natural flavor. For the green tea extract, one that is soluble in ethanol and has good evaporability may be used. Specifically, green tea extract in the form of powder or dissolved in ethanol may be used. The green tea extract is used in 0.5-5 parts by weight, preferably 1-5 parts by weight of, per 100 parts by weight of the matrix resin mixture. If the content is below 0.5 part by weight, natural flavor is hardly attained. In contrast, if it exceeds 5 parts by weight, a pleasant natural flavor is not attained because of the strong, unique flavor of green tea. Further, when the content of the green tea extract is larger than 2.5 parts by weight, the resultant foams may be deep-colored and bubbles may be foamed depending on the foaming conditions.

The wormwood extract may be used to improve the flavor, particularly to offer a natural flavor. For the wormwood extract, one that is soluble in ethanol and has good evaporability may be used. Specifically, wormwood extract dissolved in ethanol may be used. The wormwood extract is used in 0.5-5 parts by weight, preferably 1-5 parts by weight of, per 100 parts by weight of the matrix resin mixture. If the content is below 0.5 part by weight, natural flavor is hardly attained. In contrast, if it exceeds 5 parts by weight, a pleasant natural flavor is not attained because of the strong, unique flavor of wormwood.

The pine needle extract may be used to improve flavor, particularly to offer natural flavor. For the pine needle extract, one that is soluble in ethanol and has good evaporability may be used. Specifically, pine needle extract dissolved in ethanol may be used. The pine needle extract is used in 0.5-5 parts by weight, preferably 1-5 parts by weight of, per 100 parts by weight of the matrix resin mixture. If the content is below 0.5 part by weight, natural flavor is hardly attained. In contrast, if it exceeds 5 parts by weight, a pleasant natural flavor is not attained because of the strong, unique flavor of pine needle.

The powdered magnetic material may be used to activate vitality and stabilize nervous and immune systems. For the powdered magnetic material, the powder prepared by dissolving and sintering iron oleate, etc., which is prepared by reacting an iron salt such as ferric chloride (FeCl₃.6H₂O) with a fatty acid ester such as sodium oleate, (specifically, iron oxide, etc.) may be used. Preferably, the powdered magnetic material has a susceptibility of 0.001-0.01 emu (electromagnetic unit) and a diameter of 0.1-20 μm. The powdered magnetic material is used in 0.5-5 parts by weight of, preferably 1-5 parts by weight, per 100 parts by weight of the matrix resin mixture. If its content is less than 0.5 part by weight or exceeds 5 parts by weight, the wanted activation of vitality and stabilization of nervous and immune systems cannot be attained.

Hereinafter, each step of the preparation method of the injection-molded ethylene vinyl acetate based polymer foams with low density in accordance with the present invention is described.

First, a foaming composition which comprises a resin mixture comprising ethylene vinyl acetate (EVA) resin and ethylene methyl acrylate (EMA) resin as a matrix resin is blended.

The foaming composition comprises 100 parts by weight of a matrix resin comprising 50-90 parts by weight of ethylene vinyl acetate (EVA) resin and 10-50 parts by weight of ethylene methyl acrylate (EMA) resin and an adequate amount of additives including a processing aid, a foaming aid, a flow enhancer, a lubricant, a crosslinking agent, a foaming agent, etc. The foaming composition is blended in the temperature range of 80-120° C.

Further, 0.5-5.0 parts by weight of silver nanoparticles, 0.5-5.0 parts by weight of nanoclay, 0.5-5.0 parts by weight of powdered magnetic material, 0.5-5.0 parts by weight of green tea extract, 0.5-5.0 parts by weight of wormwood extract or 0.5-5.0 parts by weight of pine needle extract may be added.

During the blending, if the blending is performed below 80° C., physical mixing may not be completed. In contrast, if it exceeds 120° C., foaming occurs too early so that the product may not be produced. The time required for the blending may vary depending on the amount of the total composition to be used. However, it is preferred to conduct for 10-15 minutes. The blending may be performed using a blending machine commonly used in the related art, for example, kneader, Banbury mixer, inter-mixer, batch mixer, press mixer, intensive mixer, etc.

The resultant blend is masticating under specific conditions. The mastication is performed at 80-100° C. If the mastication temperature is below 80° C., the foams may be broken during the processing, failing to be rolled around the roll surface. In contrast, if it exceeds 100° C., the foaming agent may be decomposed, thus resulting in early foaming. Preferably, the mastication may be performed for 5-10 minutes and repeated 3-5 times. The mastication may be performed using a commonly used in the related art, for example, a roller, a calender, an extruder, etc.

The mastication is followed by pelletizing. The pelletizing is performed at 30-80° C., preferably 40-80° C. If the pelletizing is performed below 30° C., coagulation may occur during the pelletizing, thus making the injection inappropriate. In contrast, if it exceeds 80° C., it may lead to early foaming and coagulation. Unless the aforesaid pelletizing condition is satisfied, severe cutting may occur during the pelletizing. The pelletizing may be performed using, for example, a pelletizer. Preferably, the screw speed of the pelletizer is adjusted at 20-30 rpm.

Foaming is performed following the blending, mastication and pelletizing. Preferably, the foaming is performed for 420-3600 seconds at 135-180° C. and 80-120 kg/cm². More preferably, the foaming is performed by foam injection. If the foaming temperature is below 135° C., the injection time increases significantly, thus raising difficulty in performing the demolding process. In contrast, if it exceeds 180° C., the injection-molded product may be torn or induce bursting during demolding. If the foaming time is shorter than 420 seconds, the product formation may be difficult because of insufficient crosslinking foaming. In contrast, if the foaming time exceeds 3600 seconds, the product may be torn or broken because of overcrosslinking. That is, unless the aforesaid foaming condition is fully satisfied, it is difficult to attain an ideal appearance because of insufficient formability.

And, the contents of silver nanoparticles, nanoclay, a powdered magnetic material, a green tea extract, a wormwood extract, a pine needle extract, etc., which are added to provide special functions, greatly affect the degree of foaming and functional capacities.

The silver nanoparticles may be silver nanoparticles in the form of powder or colloid. The nanoclay may be added as dispersed in ethanol. The powdered magnetic material may be added in the form of powder or after dissolving it in ethanol. The green tea extract may be added in the form of powder or as dissolved in ethanol. And, the wormwood extract and the pine needle extract may be added as dispersed in ethanol.

Preferably, the silver nanoparticles, nanoclay, powdered magnetic material, a green tea extract, a wormwood extract, a pine needle extract, etc., are dispersed in a solvent such as ethanol and then mixed with the matrix resin in order to improve dispersibility.

The silver nanoparticles may be pretreated with silica colloid to adjust the concentration of the reaction mixture to control the particle size distribution of the silver nanoparticles.

For the nanoclay, one that can improve the stability of the foams and provide flame retardance may be used. The nanoclay may have a specific surface area of 12-15 m²/g and an average diameter of 1128-1400 nm. Preferably, the nanoclay is used in the amount of 0.1-2.0 parts by weight, per 100 parts by weight of the matrix, considering the hardness of the master batch.

When the powdered magnetic material is added, the foaming temperature and time should be carefully controlled to ensure sufficient foaming without impairing the physical properties of the powdered magnetic material. The adequate foaming temperature is 150° C. or lower, preferably 135-145° C. and the time required for adequate foaming is 600 seconds or longer, preferably 1200-3600 seconds.

Especially, when the green tea extract is added, the foaming temperature and time should be carefully controlled to ensure sufficient foaming without impairing the physical properties of the green tea extract. The adequate foaming temperature is 150° C. or lower, preferably 135-145° C. and the time required for adequate foaming is 600 seconds or longer, preferably 1200-3600 seconds.

And, when the wormwood extract is added, the foaming temperature and time should be carefully controlled to ensure sufficient foaming without impairing the physical properties of the wormwood extract. The adequate foaming temperature is 150° C. or lower, preferably 135-145° C. and the time required for adequate foaming is 600 seconds or longer, preferably 1200-3600 seconds.

When the pine needle extract is added, the foaming temperature and time should be carefully controlled to ensure sufficient foaming without impairing the physical properties of the pine needle extract. The adequate foaming temperature is 150° C. or lower, preferably 135-145° C. and the time required for adequate foaming is 600 seconds or longer, preferably 1200-3600 seconds.

The EVA based foams of the present invention, which are prepared from the aforementioned composition by the aforesaid preparation method, enable an injection-molding expansion, have an expansion ratio of 155-170%, a hardness of 15-18 (Asker C Type), a specific gravity of 0.16-0.18 and have low hardness and small specific gravity. Therefore, they are lighter, softer and smoother than the conventional foams, and thus can be utilized in medical or health-care products.

The addition of the silver nanoparticles, a green tea extract, a wormwood extract, a pine needle extract, etc., may contribute to the improvement of antibacterial effect, natural flavor, etc. The addition of the powdered magnetic material may contribute to the improvement of vitality and stabilization of nervous and immune systems. And, the addition of the nanoclay may improve the barrier effect against such gases as oxygen, carbon dioxide, other compounds, etc., thereby enabling an extended, stable use of the product and improving flame retardance, etc.

### BRIEF DESCRIPTION OF THE DRAWINGS

FIG. 1 shows the FT-IR (Fourier transform-infrared) spectra of the powdered magnetic material [SM] prepared in Preparation Example 2. NF-900 shows the analysis result for the ferrite powder purchased from TaePyongYang Metal, SM-900 is the result obtained by sintering at 900° C. and SM is the result obtained without sintering.

FIG. 2 shows the electron micrographs of the powdered magnetic material [SM] prepared in Preparation Example 2. (a) and (b) are the electron micrographs of the ferrite powder purchased from TaePyongYang Metal and (c) and (d) are the electron micrographs of the powdered magnetic material [SM] prepared in Preparation Example 2.

In FIG. 3, (a) is the graph showing the temperature-dependent susceptibility of the ferrite powder purchased from TaePyongYang Metal, (b) is the graph showing the temperature-dependent susceptibility of the powdered magnetic material prepared in Preparation Example 2 and sintered at 300° C. [SM-300] and (c) is the graph showing the temperature-dependent susceptibility of the powdered magnetic material prepared in Preparation Example 2 and sintered at 900° C. [SM-900].

### BEST MODE FOR CARRYING OUT THE INVENTION

Practical and preferred embodiments of the present invention are illustrated as shown in the following examples. However, it will be appreciated that those skilled in the art may, in consideration of this disclosure, make modifications and improvements within the spirit and scope of the present invention.

### Examples 1 to 4 and Comparative Examples 1 to 5

The compositions given in Table 1 below were blended in a kneader at 115-120° C. for 10-12 minutes, repeatedly masticated at 80-90° C. for 3-5 times using a roller, pelletized at 30-35° C. using a pelletizer revolving at 28-30 rpm and injection-foamed at 170-175° C. and 90-120 kg/cm² for 420-600 seconds to obtain foams.

TABLE 1
Composition

| (parts by | Example No. | | | | Comparative Example No. | | | | |
|---|---|---|---|---|---|---|---|---|---|
| weight) | 1 | 2 | 3 | 4 | 1 | 2 | 3 | 4 | 5 |
| EVA1¹⁾ | — | — | — | — | — | — | — | — | 100 |
| EVA2²⁾ | 70 | 60 | 80 | 90 | — | — | — | — | — |
| EMA³⁾ | 30 | 40 | 20 | 10 | — | — | — | — | — |
| SES⁴⁾ | — | — | — | — | 100 | — | — | — | — |
| SEPS¹⁾ | — | — | — | — | — | 100 | — | — | — |
| SIS1⁶⁾ | — | — | — | — | — | — | 100 | — | — |
| SIS2⁷⁾ | — | — | — | — | — | — | — | 100 | — |
| Processing aid⁸⁾ | 1 | 1 | 2 | 1 | 1 | 1 | 1 | 1 | 1 |
| Foaming aid⁹⁾ | 0.5 | 0.5 | 1 | 0.5 | 0.5 | 0.5 | 0.5 | 0.5 | 0.5 |
| Flow | 1 | 1 | 2 | 1 | 1 | 1 | 1 | 1 | 1 |
| enhancer¹⁰⁾ | | | | | | | | | |
| Lubricant¹¹⁾ | 15 | 20 | 10 | 6 | — | — | — | — | — |
| Crosslinking | — | — | — | — | 0.15 | — | 0.45 | 0.45 | — |
| agent1¹²⁾ | | | | | | | | | |
| Crosslinking | 0.7 | 1.1 | 0.6 | 1.1 | — | 0.75 | — | — | 0.75 |
| agent2¹³⁾ | | | | | | | | | |
| Foaming | 3 | 3 | 3.5 | 3 | 5 | 4 | 0.75 | 0.75 | 3.5 |
| agent1¹⁴⁾ | | | | | | | | | |
| Foaming | — | — | — | — | — | — | 3.75 | 3.75 | — |
| agent2¹⁵⁾ | | | | | | | | | |

¹⁾Ethylene vinyl acetate resin: VA 28, VA800, Lotte Petrochemical
²⁾Ethylene vinyl acetate resin: VA 40, 40L03, DuPont
³⁾Ethylene methyl acrylate resin: MA 25, EL1125, DuPont
⁴⁾Styrene-ethylene-styrene block copolymer: oil content 45, LG485, LG Chem
⁵⁾Polyisoprene polymer: styrene content 13, 2043, SEPTON
⁶⁾Styrene-isoprene-styrene block copolymer: styrene content 18, KTR 801, Kumho Petrochemical
⁷⁾Styrene-Isoprene-Styrene Block Copolymer; styrene content 18, KTR 802, Kumho Petrochemical
⁸⁾Stearic acid: sp. gr. 0.84, St/A, LG Chem
⁹⁾Zinc oxide: reaction-stabilized, Zn/O, Gilcheon
¹⁰⁾Zinc stearate: m.p. 116-125° C., Zn/St, Samdong Industry
¹¹⁾Process oil: sp. gr. 0.867, W-oil, Sechang Petrochemical
¹²⁾Dicumyl peroxide: purity 99%, DCP, Sinopec
¹³⁾t-Butylperoxyisopropylbenzene: purity 98%, BIPB, Sinopec
¹⁴⁾Azodicarbonamide: decomposition temperature 161-165° C., DX-74H, Dongjin
¹⁵⁾Azodicarbonamide: decomposition temperature 169° C., AD/E, Kumyang

### Experimental Example 1

Physical properties of the foams prepared in Examples 1-4 and Comparative Examples 1-5 were measured by the following standards. The results are given in Table 2 below.

(1) Hardness: ASTM D2240

(2) Specific gravity: ASTM D297

(3) Resilience: ASTM D1054

(4) Shrinkage: ASTM D1056

(5) Compression set: ASTM D3754

(6) Tear strength: ASTM D624

(7) Split tear strength: ASTM D3754

(8) Tensile strength: ASTM D412

(9) Elongation: ASTM D751

(10) Expansion Ratio: The expansion ratio of the foams was calculated from the proportion of the diagonal length of the bottom of the mold (L) to the diagonal length of the bottom of the foams (m). Expansion Ratio (%)=m/L×100.

TABLE 2

| | | Example No. | | | | Comparative Example No. | | | | |
|---|---|---|---|---|---|---|---|---|---|---|
| | | 1 | 2 | 3 | 4 | 1 | 2 | 3 | 4 | 5 |
| Hardness | Asker C | 17 | 18 | 18 | 16 | 15 | 8 | 10 | 10 | 40 |
| Specific gravity | g/cm³ | 0.168 | 0.169 | 0.171 | 0.165 | 0.124 | 0.137 | 0.135 | 0.124 | 0.143 |
| Resilience | % | 64 | 57 | 61 | 55 | 78 | 62 | 66 | 65 | 55 |
| Shrinkage | % | 3.2 | 4.3 | 5.8-6.3 | 3.1 | 4.0-5.9 | 1.5-2.6 | 3.2-5.7 | 3.1-3.9 | 1.5-1.9 |
| Compression | % | 60 | 62 | 52 | 59 | 93 | 85 | 56 | 54 | 68 |
| set | | | | | | | | | | |
| Elongation | % | 350 | 370 | 408 | 309 | 336 | 480 | 442 | 589 | 308 |
| Expansion | % | 160 | 161 | 160 | 159 | 168 | 176 | 173 | 177 | 174 |
| Ratio | | | | | | | | | | |
| Tear strength | N/mm | 1.6 | 1.7 | 2.0 | 2.1 | 0.4 | 1.0 | 1.0 | 0.9 | 3.5 |
| Split tear | N/cm | 14 | 14.2 | 14.5 | 12 | 3.3 | 7.0 | 7.5 | 7.5 | 22.0 |
| strength | | | | | | | | | | |
| Tensile strength | N/mm² | 1.1 | 1.4 | 1.2 | 1.0 | 0.4 | 0.8 | 0.6 | 0.8 | 1.9 |

As seen in Table 2, the ethylene vinyl acetate based polymer foams prepared in accordance with the present invention had a hardness of 15-18 and a specific gravity of 0.12-0.18.

### Preparation Example 1

### Preparation of Silver Nanoparticles

200 g of silver ingot was added into 500 mL of 10 wt % nitric acid solution and heated at 100° C. until all the silver ingot was dissolved while maintaining the volume at 500 mL by continuously replenishing with water. After all the silver ingot was dissolved, water was added to a total volume of 1000 mL.

To 50 mL of the silver solution were added 3 g of polyvinylpyrrolidone (molecular weight=10000) and 1 mL of sodium silicate solution (sodium silicate:water=25:75 (v/v)). After stirring, 0.3 g of NaBH₄ dissolved in 10 mL of distilled water was added. Silver nanoparticles having an average diameter of 100-180 nm was obtained by stirring and centrifugation.

### Preparation Example 2

### Preparation of Powdered Magnetic Material

10.8 g of ferric chloride (FeCl₃.6H₂O, 40 mmol, Aldrich, 98%) and 36.5 g of sodium oleate (120 mmol, TCl, 95%) were dissolved in a mixed solvent of 80 mL of ethanol, 60 mL of distilled water and 140 mL of hexane. After heating to 70° C., reaction was performed for 4 hours. The supernatant was washed with water to remove NaCl and hexane was removed using an evaporator to obtain iron oleate.

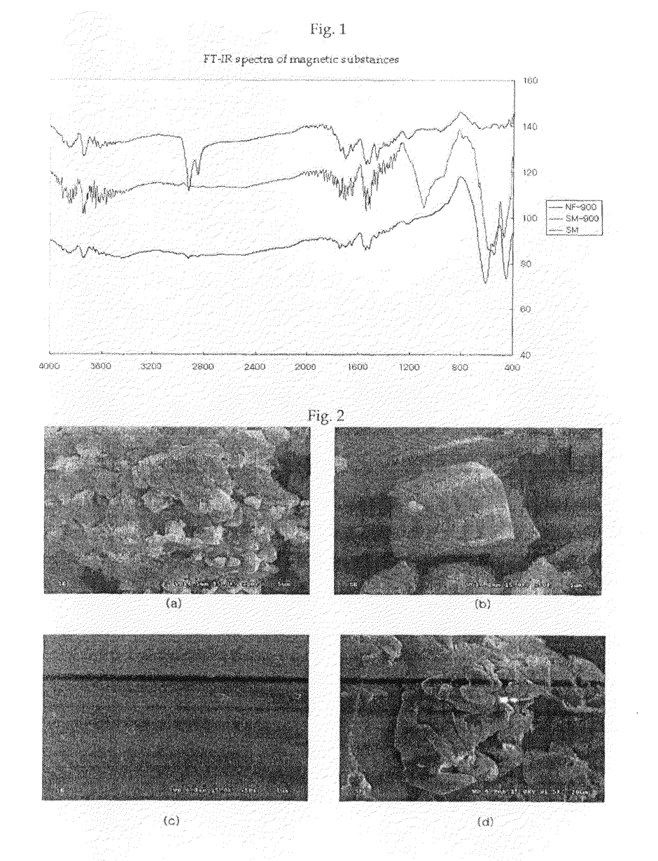

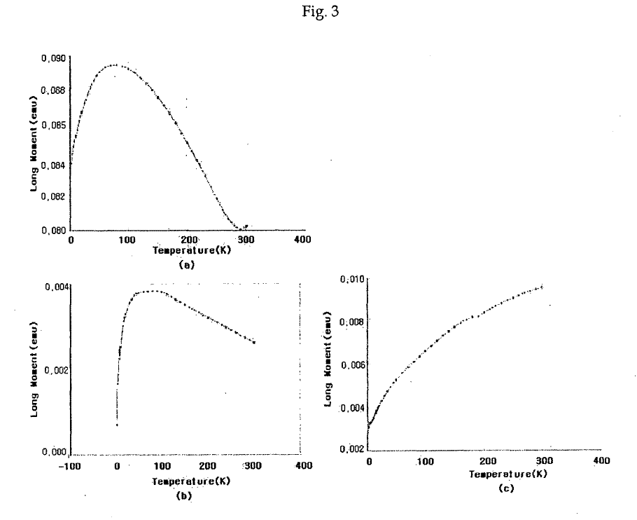

36 g of iron oleate and 5.7 g of oleic acid (Aldrich, 90%) were dissolved in 200 g of 1-octadecene (Aldrich, 90%) at room temperature. After heating to 320° C. at a rate of 3.3° C./min, the solution was kept at 320° C. for 30 minutes. Thus obtained magnetic substance (iron oxide) was cooled to room temperature and 500 mL of ethanol was added. A magnetic substance in powder form was obtained by sintering at 900° C. using an electric muffle furnace. FIG. 1 shows the IR analysis result of the resultant magnetic substance and FIG. 2 shows the electron micrographs of the magnetic substance.

### Preparation Example 3

### Preparation of Green Tea Extract

Leaves of green tea (harvested in Mt. Jiri) and ethanol were mixed at a proportion of 1:20 based on weight. Extraction was performed 2 times at 50° C. for 12 hours. After drying in a vacuum oven for 48 hours, the solvent was evaporated to obtain a wormwood extract (powdery extract, yield 15%).

### Preparation Example 4

### Preparation of Wormwood Extract

Wormwood (harvested in Mt. Jiri) and ethanol were mixed at a proportion of 1:20 based on weight. Extraction was performed 2 times at 50° C. for 12 hours. After drying in a vacuum oven for 48 hours, the solvent was evaporated to obtain a wormwood extract (liquid extract, yield 15%).

### Preparation Example 5

### Preparation of Pine Needle Extract

Pine needle (harvested in Mt. Jiri) and ethanol were mixed at a proportion of 1:20 based on weight. Extraction was performed at 50° C. for 6 hours. After drying in a vacuum oven for 48 hours, the solvent was evaporated to obtain a pine needle extract (liquid extract, yield 26.2%).

### Examples 5 and 6

To the composition of Example 3 were added 0.2 parts by weight of colloidal silver nanoparticles (Example 5) and 3 parts by weight of green tea extract (Example 6) dissolved in ethanol to a concentration of 7 wt %. Blending and mastication were performed under the same condition as in Example 1. Then, injection-foaming was performed at 140° C. and 100 kg/cm² for 20-40 minutes to obtain foams.

### Experimental Example 2

The foams obtained in Example 5 were prepared into 2.5×2.5×0.2 cm size samples. After sterilizing with UV, antibacterial activity was evaluated using Staphylococcus aureus.

Antibacterial activity was measured by culturing Staphylococcus aureus on a plate at 37° C. under aerobic condition for 16 hours and counting the number of colonies. Light absorbance (OD) was measured at 600 nm. The cells were diluted when the absorbance was 0.1. 0.1 mL of the cell solution was applied to the UV-sterilized foam samples by the film contact method (FC-TM-20). After culturing at 37° C. under aerobic condition for 24 hours, the number of colonies was counted to evaluate antibacterial activity. The results are given in Table 3 below.

TABLE 3

| | Initial | After 24 hours' culturing |
|---|---|---|
| Example 3 | 3.50 × 10² cfu/mL | 6.50 × 10² cfu/mL |
| Example 5 | 3.90 × 10² cfu/mL | 0.55 × 10² cfu/mL |

As seen in Table 3, the foams comprising silver nanoparticles (Example 5) showed about 86% of outstanding antibacterial activity, in comparison with the foams comprising no silver nanoparticles (Example 3), although both of them were prepared with the same composition and by the same method.

And, the foams comprising green tea extract (Example 6) kept natural flavor for about 4-6 months, in comparison with the foams comprising no green tea extract (Example 3), although both of them were prepared with the same composition and by the same method.

### Experimental Example 3

3-4 months old male rabbits (New Zealand White Rabbit, purchased from Samtako, body weight=2.0-3.0 kg) were accustomed to the laboratory condition for about 1 week. 6 healthy rabbits were tested. An experiment was performed under the condition of 20±2° C., R.H. 50±10%, ventilation 10-12 times/hr, lighting 12 hours at 200-300 lux. The rabbits were freely given with the feed for animal tests (Purina Korea) and UV-sterilized drinking water.

Two areas (about 2.5×2.5 cm, left and right side of the spine) were selected at the back of the rabbits. The abraded and non-abraded sites of the upper part were treated with the experimental material (the foams prepared in Example 5) and the two lower sites were untreated (sterilized gauge). Hair had been removed from the test sites 24 hours before the experiment. After applying the experimental material and the sterilized gauge, cap tape was used to cover the sites. After 24 hours of exposure, the test sites were cleansed with warm water and the followings were observed.

1) General Symptoms

General symptoms, poisoning symptoms and deaths were observed up to 72 hours after treating with the experimental material. No symptoms or deaths were observed.

2) Body Weight

Body weight was measured just before treating with the experimental material, after 24 hours and after 72 hours. All the animals showed normal body weight increase during the experimental period.

3) Observation of Test Sites

Patches were removed from the test sites and irritations such as red spots, crusts, edemas, etc. were observed after 24 hours and 72 hours, respectively. No red spots, crusts or edemas were observed after 24 hours and 72 hours, respectively. Primary skin irritation evaluated by Draize's P.I.I. (primary irritation index) was “0 (zero).”

TABLE 4

| P.I.I.¹⁾ | Degree of irritation |
|---|---|
| 0.0-0.5 | Nonirritating |
| 0.6-2.0 | Mildly irritating |
| 2.0-5.0 | Moderately irritating |
| 5.1-8.0 | Severely irritating |

¹⁾Primary irritation index, sum of means/4

As seen in Table 4, the low density injection-molded foams prepared in accordance with the present invention were confirmed to be non-irritating to skin. Thus, the foams of the present invention can be utilized to manufacture various medical and health-care products.

### Examples 7 to 11

### Physical Property Change Dependent on Nanoclay Content

Nanoclay (diameter 1128-1500 nm) was added to the composition of Example 3 as in Table 5. Blending and mastication were performed as in Example 1. Injection molding was performed at 140° C. and 100 kg/cm² for 20-40 minutes to obtain foams.

### Examples 12 to 16

### Physical Property Change Dependent on Powdered Magnetic Material Content

The powdered magnetic material (average diameter 0.5 μm or less) prepared in Preparation Example 2 was added to the composition of Example 3 as in Table 5. Blending and mastication were performed as in Example 1. Injection molding was performed at 140° C. and 100 kg/cm² for 20-40 minutes to obtain foams.

### Examples 17 to 21

### Physical Property Change Dependent on Green Tea Extract Content

The green tea extract prepared in Preparation Example 3 and dissolved in ethanol to a concentration of 7 wt % was added to the composition of Example 3 as in Table 5. Blending and mastication were performed as in Example 1. Injection molding was performed at 140° C. and 100 kg/cm² for 20-40 minutes to obtain foams.

### Examples 22 to 26

### Physical Property Change Dependent on Wormwood Extract Content

The wormwood extract prepared in Preparation Example 4 and dissolved in ethanol to a concentration of 7 wt % was added to the composition of Example 3 as in Table 5. Blending and mastication were performed as in Example 1. Injection molding was performed at 140° C. and 100 kg/cm² for 20-40 minutes to obtain foams.

### Examples 27 to 31

### Physical Property Change Dependent on Pine Needle Extract Content

The pine needle extract prepared in Preparation Example 5 and dissolved in ethanol to a concentration of 7 wt % was added to the composition of Example 3 as in Table 5. Blending and mastication were performed as in Example 1. Injection molding was performed at 140° C. and 100 kg/cm² for 20-40 minutes to obtain foams.

### Experimental Example 4

Physical properties of the foams prepared in Example 5-31 were measured by the following standards. The result is given in Table 5 below.

(1) Hardness: ASTM D2240

(2) Specific gravity: ASTM 3575

(3) Resilience: DIN 53512

(4) Shrinkage: ASTM D1056, 70° C.×40 min

(5) Compression set: ASTM D395

(6) Tear strength: ASTM D624

(7) Split tear strength: ASTM D3574

(8) Tensile strength: ASTM D412

(9) Elongation: ASTM D412

(10) Expansion Ratio (ER): The expansion ratio of the foams was calculated from the proportion of the diagonal length of the bottom of the mold (L) to the diagonal length of the bottom of the foams (m). Expansion Ratio (%)=m/L×100.

TABLE 5

| | | Category | | | | | | | | | | |
|---|---|---|---|---|---|---|---|---|---|---|---|---|
| | | | | | Specific | | | | Tear | Split tear | | Expansion |
| | | Added material | | Hardness | gravity | Resilience | Shrinkage²⁾ | C. set | strength | strength | Elongation | Ratio |
| | | Category | | | | | | | | | | |
| | | Content | | | | | | | | | | |
| | | (parts by weight)¹⁾ | | Asker C | g/cm³ | % | % | % | kg/cm | kg/cm | % | % |
| Example | 7 | Clay | 0.1 | 15 | 0.167 | 59 | 2.0³⁾/2.1⁴⁾ | 54 | 7.0 | 1.71 | 505 | 165 |
| | 8 | Clay | 0.3 | 16 | 0.169 | 60 | 2.5/2.3 | 60 | 7.0 | 1.87 | 576 | 165 |
| | 9 | Clay | 0.5 | 16 | 0.174 | 61 | 1.8/2.1 | 49 | 7.6 | 1.67 | 461 | 165 |
| | 10 | Clay | 1.0 | 16 | 0.177 | 60 | 1.3/2.1 | 48 | 7.3 | 1.9 | 486 | 165 |
| | 11 | Clay | 2.0 | 17 | 0.18 | 58 | 1.3/1.8 | 45 | 7.4 | 1.95 | 484 | 165 |
| | 12 | Magnetic | 0.1 | 15 | 0.178 | 61 | 2.5/3.6 | 64.7 | 7.0 | 1.75 | 491 | 164 |
| | | substance | | | | | | | | | | |
| | 13 | Magnetic | 0.3 | 15 | 0.163 | 61 | 3.0/3.6 | 62.8 | 5.4 | 1.65 | 445 | 163 |
| | | substance | | | | | | | | | | |
| | 14 | Magnetic | 0.5 | 15-16 | 0.171 | 61 | 2.5/3.6 | 61.7 | 5.8 | 1.73 | 461 | 161 |
| | | substance | | | | | | | | | | |
| | 15 | Magnetic | 1.0 | 16-17 | 0.168 | 61 | 2.5/3.6 | 61.5 | 5.7 | 1.7 | 444 | 163 |
| | | substance | | | | | | | | | | |
| | 16 | Magnetic | 2.0 | 16 | 0.164 | 62 | 2.8/4.3 | 61.7 | 6. | 1.61 | 414 | 165 |
| | | substance | | | | | | | | | | |
| | 17 | Green tea | 0.1 | 15 | 0.17 | 61 | 3.8/4.3 | 49.1 | 6.2 | 1.46 | 396 | 170 |
| | 18 | Green tea | 0.3 | 17 | 0.173 | 60 | 3.8/3.2 | 51 | 7.7 | 1.52 | 372 | 168 |
| | 19 | Green tea | 0.5 | 17 | 0.175 | 58 | 5.0/3.2 | 61.6 | 7.7 | 1.69 | 441 | 168 |
| | 20 | Green tea | 1.0 | 18 | 0.18 | 54 | 3.8/3.6 | 71 | 11.0 | 1.6 | 602 | 165 |
| | 21 | Green tea | 2.0 | 18 | 0.18 | 54 | 3.8/3.9 | 79 | 14.1 | 1.65 | 555 | 165 |
| | 22 | Wormwood | 0.1 | 15 | 0.166 | 61 | 3.8/3.2 | 47.5 | 6.9 | 1.4 | 370 | 166 |
| | 23 | Wormwood | 0.3 | 17 | 0.167 | 61 | 2.5/3.2 | 49.9 | 6.0 | 1.48 | 423 | 167 |
| | 24 | Wormwood | 0.5 | 17 | 0.17 | 61 | 2.5/3.2 | 46.6 | 7.5 | 1.52 | 384 | 166 |
| | 25 | Wormwood | 1.0 | 17 | 0.175 | 60 | 2.5/2.9 | 48 | 7.1 | 1.48 | 347 | 165 |
| | 26 | Wormwood | 2.0 | 18 | 0.18 | 60 | 2.5/3.2 | 50.4 | 7.0 | 1.50 | 379 | 165 |
| | 27 | Pine needle | 0.1 | 15 | 0.164 | 61 | 3.8/4.3 | 45.9 | 7.4 | 1.63 | 409 | 165 |
| | 28 | Pine needle | 0.3 | 16 | 0.170 | 60 | 2.5/3.6 | 46.7 | 7.2 | 1.59 | 410 | 164 |
| | 29 | Pine needle | 0.5 | 16 | 0.171 | 59 | 2.5/2.9 | 50.3 | 7.3 | 1.52 | 420 | 165 |
| | 30 | Pine needle | 1.0 | 17 | 0.18 | 59 | 2.5/2.9 | 52.9 | 8.0 | 1.54 | 380 | 166 |
| | 31 | Pine needle | 2.0 | 18 | 0.18 | 56 | 2.5/3.7 | 48.5 | 7.7 | 1.71 | 395 | 164 |

¹⁾Relative content per 100 parts by weight of matrix resin
²⁾70° C. × 40 min
³⁾Width shrinkage
⁴⁾Length shrinkage

As seen in Table 5, the low density injection-molded foams of the present invention can be prepared into various functional foams by adding nanoclay, powdered magnetic material, green tea extract, wormwood extract, pine needle extract, etc. When the nanoclay, powdered magnetic material, a green tea extract, a wormwood extract, a pine needle extract, etc., were added, the low density injection-molded foams of the present invention maintain low hardness, low specific gravity and superior injection formability.

### INDUSTRIAL APPLICABILITY

As explained hereinbefore, the present invention enables the preparation of foams having superior injection formability using ethylene vinyl acetate (EVA) resin as a matrix resin. Since the ethylene vinyl acetate (EVA) based foams of the present invention have small specific gravity, low hardness and soft touch, they can be safely used for skin.

Further, since antibacterial effect or natural flavor can be provided by adding silver nanoparticles, nanoclay, a green tea extract, a wormwood extract, a pine needle extract, powdered magnetic material, etc., the foams can be effectively used in health-care or medical products and a variety of everyday goods.

Those skilled in the art will appreciate that the concepts and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the present invention as set forth in the appended claims.

1. Injection-molded ethylene vinyl acetate based polymer foams comprising a composition which comprises a resin mixture of 50-90 parts by weight of ethylene vinyl acetate (EVA) resin and 10-50 parts by weight of ethylene methyl acrylate (EMA) resin as a matrix resin and having a hardness of 15-18 and a specific gravity of 0.16-0.18.

2. The injection-molded ethylene vinyl acetate based polymer foams as set forth in claim 1, wherein the composition comprises silver nanoparticles.

3. The injection-molded ethylene vinyl acetate based polymer foams as set forth in claim 1, wherein the composition comprises green tea extract.

4. The injection-molded ethylene vinyl acetate based polymer foams as set forth in claim 1, wherein the composition comprises powdered magnetic material.

5. The injection-molded ethylene vinyl acetate based polymer foams as set forth in claim 1, wherein the composition comprises nanoclay.

6. The injection-molded ethylene vinyl acetate based polymer foams as set forth in claim 1, wherein the composition comprises a wormwood extract.

7. The injection-molded ethylene vinyl acetate based polymer foams as set forth in claim 1, wherein the composition comprises pine needle extract.

8. A preparation method of injection-molded ethylene vinyl acetate based polymer foams comprising the steps of:
blending a foaming composition comprising a resin mixture of 50-90 parts by weight of ethylene vinyl acetate (EVA) resin and 10-50 parts by weight of ethylene methyl acrylate (EMA) resin as a matrix resin; and
masticating, pelletizing and foaming the resultant blend.

9. The preparation method of injection-molded ethylene vinyl acetate based polymer foams as set forth in claim 8, wherein the mastication is repeated 3-5 times at 80-100° C.

10. The preparation method of injection-molded ethylene vinyl acetate based polymer foams as set forth in claim 8, wherein the pelletizing is performed at 30-80° C. at a revolution rate of 20-30 rpm.

11. The preparation method of injection-molded ethylene vinyl acetate based polymer foams as set forth in claim 8, wherein the foaming is performed at 135-180° C. by injection molding.

12. The preparation method of injection-molded ethylene vinyl acetate based polymer foams as set forth in claim 8, wherein at least one selected from silver nanoparticles, a green tea extract, nanoclay, a powdered magnetic material, a wormwood extract and a pine needle extract is further added to the matrix resin.

13. A medical product prepared from the ethylene vinyl acetate based polymer foams as set forth in claim 1.

14. A health-care product prepared from the ethylene vinyl acetate based polymer foams as set forth in claim 1.
